(19) United States
(12) Patent Application Publication
(10) Pub. No.: US 2013/0040182 A1
(43) Pub. Date: Feb. 14, 2013

(54) STACKED SECONDARY CELL

(71) Applicant: Takao Daidoji, Kanagawa (JP)

(72) Inventor: Takao Daidoji, Kanagawa (JP)

(73) Assignee: NEC ENERGY DEVICES, LTD., Sagamihara-shi, Kanagawa (JP)

(21) Appl. No.: 13/643,209

(22) PCT Filed: May 10, 2011
(86) PCT No.: PCT/JP2011/060753

§ 371 Date: Oct. 24, 2012

(30) Foreign Application Priority Data
May 18, 2010 (JP) 2010-114240

(51) Int. Cl. H01M 2/18; H01M 10/04

(52) U.S. Cl. 429/139; 29/623.1; 29/623.5

(57) ABSTRACT

A stacked secondary cell suppresses heat contraction of the opening of a sack-shaped separator even in a high-temperature environment and prevents the occurrence of short circuits between the stacked electrodes. In the disclosed stacked secondary cell, positive electrodes (13) and negative electrodes each having a lead-out terminal (2) are alternately stacked with interposed separators (15). Of positive electrodes (13) and negative electrodes, at least electrodes of one polarity are each housed in sack-shaped separator sacks (15) each formed by two sheet-shaped separators that are bonded together with an opening (3) in one portion. Further, the lead-out terminal (2) of the electrode (13) that is housed in the separator sack (15) protrudes through the opening (3) to the exterior of the separator sack (15), and the outer periphery of the opening (3) is covered by an electric insulating layer (8).

### TECHNICAL FIELD

The present invention relates to a stacked secondary cell, and more particularly relates to a stacked secondary cell in which both surfaces of electrodes are covered by separators and stacked.

### BACKGROUND ART

Secondary cells that can be charged are used in electric-power assisted bicycles, electric-powered motorbikes, or uninterruptible power supply devices.

Secondary cells also include a stacked type. In a stacked secondary cell, a stacked unit is formed by alternately stacking a plurality of positive electrodes and a plurality of negative electrodes with separators interposed, the electrodes each being connected to leads for current collection. The stacked unit is then sealed together with an electrolyte in a receptacle formed by a laminated film.

A fine porous film made from synthetic resin such as polyethylene or polypropylene is typically used as the separator that electrically isolates the positive electrodes and negative electrodes.

In addition, as one example of the related art, Patent Document 1 discloses a laminated secondary cell that uses sack-shaped separators.

FIG. 1A is a schematic block diagram of the sack-shaped separator of an example of the related art, and shows a schematic sectional view of a sack-shaped separator and the positive electrode that is inserted in the separator. FIG. 1B is a schematic block diagram of the sack-shaped separator of an example of the related art, and is an outer schematic view of a positive electrode that is housed in the sack-shaped separator.

In the secondary cell of the related art, positive electrodes and negative electrodes that are each inserted in a separator sack are alternately stacked to form a stacked unit. FIGS. 1A and 1B show states in which a positive electrode is inserted in a separator sack. Negative electrodes are of the same configuration.

Separator sack 26 is of a sack shape in which two sheet-shaped separators are joined together. Positive electrode 21 from which terminal (lead-out terminal) 22 for conductive connection is led out is housed inside this separator sack 26. Fused joined portions 24 in which the two sheet-shaped separators are joined together with spaces opened between the fused joined portions are provided around the circumference of positive electrode 21 of separator sack 26. The two sheet-shaped separators are joined together by these fused joined portions 24 to form a sack shape. Fused sealing portion 25 in which the two sheet-shaped separators are continuously bonded together is provided on the outer periphery of fused joined portions 24. Lead-out terminal 22 protrudes to the exterior of separator sack 26 through electrode lead-out portion 23, which is an opening in separator sack 26. At this time, the position of lead-out terminal 22 that leads out from positive electrode 21 differs from the position of the lead-out terminal that leads out from a negative electrode (not shown). As a result, lead-out terminals 22 of positive terminals 21 and the lead-out terminals of the negative electrodes do not make contact (for example, refer to Patent Document 1).

Providing fused sealing portion 25 has the advantage of preventing active material that separates from positive electrode 21 from flowing out of separator sack 26 and further provides the effect of limiting contraction resulting from the heat of separator sack 26.

Separator sack 26 is fabricated by bonding together two sheet-shaped separators produced by extending a resin such as polypropylene or polyethylene and therefore contracts when exposed to high temperature. When a typical separator is kept at 105° C. for one hour, the contraction rate is 3%-4%.

### LITERATURE OF THE PRIOR ART

### Patent Documents

Patent Document 1: JP 2003-017112A.

### SUMMARY OF THE INVENTION

### Problem to be Solved by the Invention

In the related art described in Patent Document 1, lead-out terminal 22 of positive electrode 21 that protrudes from separator sack 26 (see FIGS. 1A and 1B) and the lead-out terminal of a negative electrode that similarly protrudes from a separator sack are not arranged at positions that overlap in a plane, and short circuits therefore do not normally occur. However, the housing of the positive electrodes and negative electrodes in respective separator sacks raises the problem of complexity and increased manufacturing costs in the manufacturing steps relating to the fabrication of the separator sacks and the insertion of each electrode into a separator sack.

A configuration can therefore be considered in which only the electrodes of one polarity (for example, positive electrodes 21) are housed in separator sacks 26. However, the electrodes that are housed in separator sacks 26 are exposed from the electrode lead-out portions 23, raising the potential that they may come into contact with neighboring electrodes that are not housed in separator sacks 26 and thus cause a short circuit to occur. More specifically, when separator sacks 26 contract, positive electrodes 21 are exposed from separator sacks 26 and come into contact with negative electrodes that are not housed in separator sacks, resulting in the occurrence of a short circuit and raising the danger of fire or ruptures. Because fused sealing portions 25 are not damaged by heat, positive electrodes 21 are not exposed from fused sealing portions 25. However, by necessity, electrode lead-out portions 23 are included in separator sacks 26, and lead-out terminals 22 protrude from within separator sacks 26 to the exterior of separator sacks 26 by way of electrode lead-out portions 23 as shown in FIG. 1. As a result, fused sealing portion 25 cannot be provided at electrode lead-out portion 23. Accordingly, when separator sacks 26 are exposed to high temperatures, electrode lead-out portions 23 undergo thermal contraction (the outer peripheries of separator sacks 26 move toward the centers of separator sacks 26), whereby the possibility arises of positive electrodes 21 being exposed from electrode lead-out portions 23, as shown in FIG. 2. In such cases, the possibility exists of the occurrence of short circuits between exposed positive electrodes 21 and negative electrodes that are not housed in separator sacks.

To prevent the occurrence of short circuits between overlapping positive electrodes 21 and negative electrodes, both types of electrodes must be housed in separator sacks 26, as in the related art of Patent Document 1, whereby cost reduction becomes problematic. In addition, when electrodes of both types are each housed in respective separator sacks, the positive electrodes and negative electrodes are exposed at the electrode lead-out portions of each due to the above-described thermal contraction of the separator sacks. Depending on the degree of thermal contraction, the exposed portions of the positive electrodes and negative electrodes may be extreme, whereby a slight divergence in position raises the potential for contact and the occurrence of short circuits.

As a result, the present invention proposes a stacked secondary cell in which thermal contraction of the opening of a sack-shaped separator in a high-temperature environment is suppressed and the occurrence of short circuits between electrodes is prevented.

### Means for Solving the Problem

In the stacked secondary cell of the present invention, positive electrodes and negative electrodes each having a lead-out terminal are alternately stacked with separators interposed. Of the positive electrodes and negative electrodes, electrodes of at least one polarity are each housed in sack-shaped separator sacks each formed by bonding together two sheet-shaped separators, and moreover, each having an opening in one portion. In addition, a lead-out terminal of an electrode that is housed inside a separator sack protrudes outside the separator sack via an opening. The outer periphery of the opening is covered by an electric insulating layer.

### Effect of the Invention

According to the present invention, the thermal contraction of the opening of the sack-shaped separator can be suppressed even in a high-temperature environment, whereby the occurrence of short-circuits between electrodes can be prevented.

### BRIEF DESCRIPTION OF THE DRAWINGS

FIG. 1A is a schematic block diagram of a sack-shaped separator of one example of the related art, and is a schematic sectional view of a sack-shaped separator and a positive electrode that is inserted in this sack-shaped separator.

FIG. 1B is a schematic block diagram of the sack-shaped separator of one example of the related art and is an outer schematic view of a positive electrode that is housed in a sack-shaped separator.

FIG. 2 shows the state in which a sack-shaped separator of one example of the related art has undergone thermal contraction.

FIG. 3A is a schematic block diagram of an exemplary embodiment of a stacked secondary cell according to the present invention and is an outer schematic view of the stacked secondary cell.

FIG. 3B is a schematic block diagram of an exemplary embodiment of the stacked secondary cell according to the present invention and is a schematic block diagram of the stacked unit.

FIG. 4A is a schematic block diagram of the separator sack of the present invention and is a schematic sectional view of a separator sack and a positive electrode that is inserted in the separator sack.

FIG. 4B is a schematic block diagram of the separator sack of the present invention and is an outer schematic view of a positive electrode housed in the separator sack.

FIG. 5 is a schematic sectional view of another separator sack of the present invention and a positive electrode that is inserted in the separator sack.

FIG. 6 shows the test results of a working example and a comparative example.

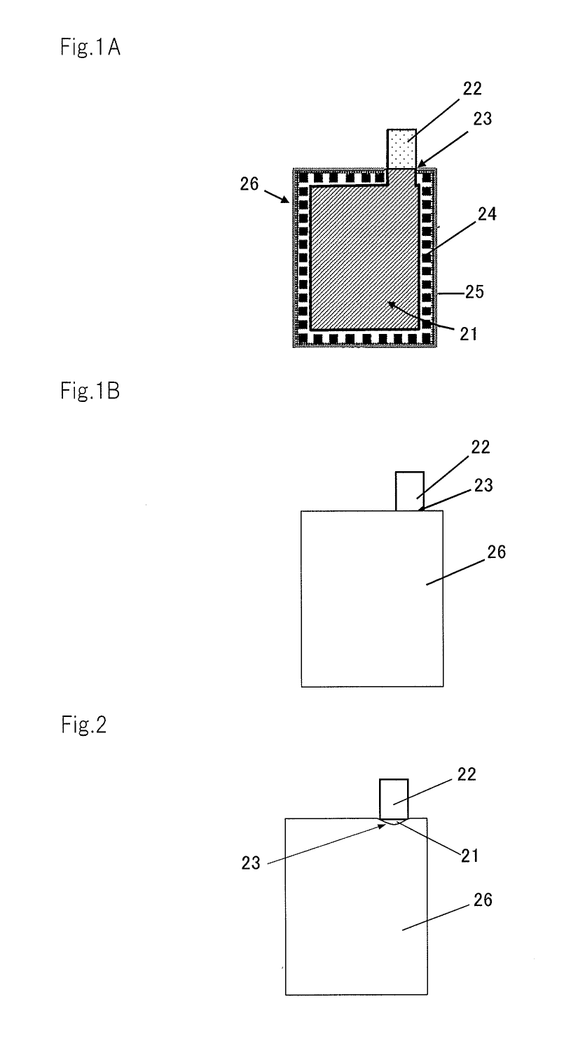

### BEST MODE FOR CARRYING OUT THE INVENTION

An exemplary embodiment of the present invention is next described based on the accompanying drawings. Constructions having the same function are given the same numbers in the accompanying drawings, and redundant explanation of these constructions may be omitted.

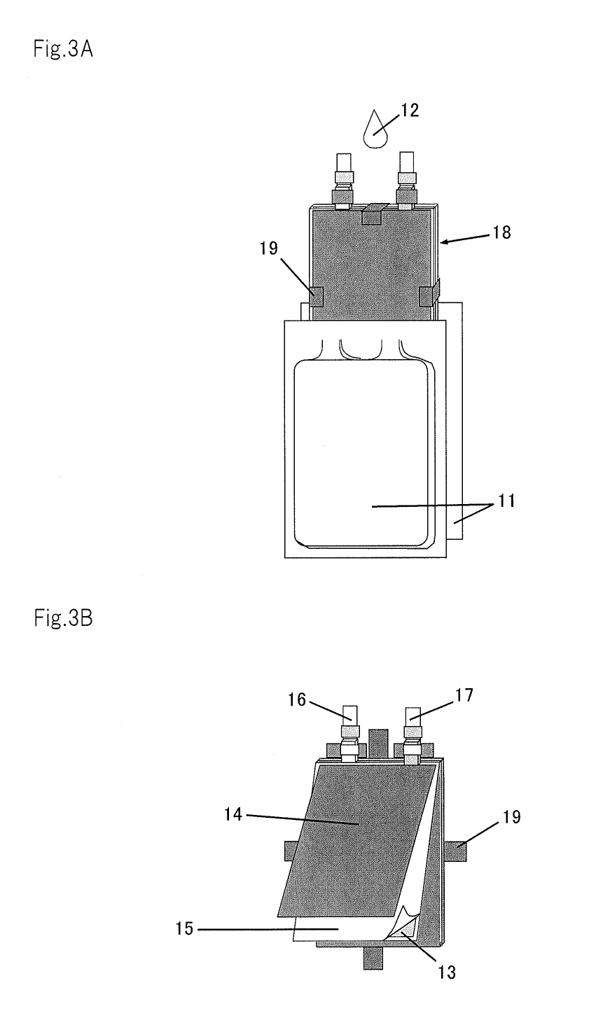

FIG. 3A is a schematic block diagram of an exemplary embodiment of the secondary cell according to the present invention and is an outer schematic view of the secondary cell. FIG. 3B is a schematic block diagram of an exemplary embodiment of the secondary cell according to the present invention and is a schematic block diagram of the stacked unit.

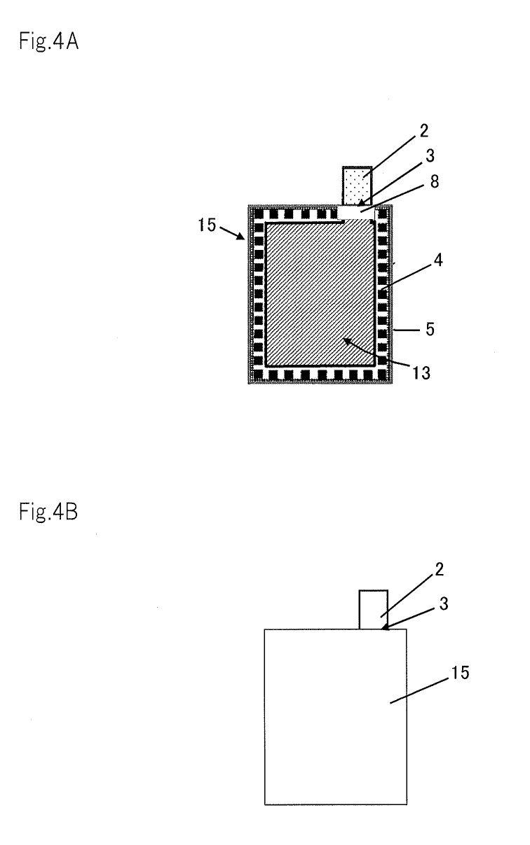

Two sheet-shaped separators are adhered together to form separator sack 15. Stacked unit (cell element) 18 is formed by alternately stacking sheet-shaped negative electrodes 14 and sheet-shaped positive electrodes 13 that are enclosed in separator sacks 15 and stacked unit 18 is secured by securing tape 19. In addition, lead-out terminals 2 (see FIG. 4A) are provided in both positive electrodes 13 and negative electrodes 14. Lead-out terminals 2 of positive electrodes 13 are connected to aluminum lead 16 for corrent collection. Lead-out terminals (not shown) of negative electrodes 14 are connected to nickel lead 17. Stacked unit 18 is sealed together with electrolyte 12 inside a receptacle of aluminum laminated film 11. The position at which lead-out terminals 2 of positive electrodes 13 are provided differs from the position at which the lead-out terminals of negative electrodes 14 are provided, whereby lead-out terminals 2 of positive electrodes 13 and the lead-out terminals of negative electrodes 14 do not come into contact with each other and a short circuit does not occur.

As described hereinabove, A fine porous film made from a synthetic resin such as polyethylene or polypropylene is typically used for the two sheet-shaped separators that make up separator sack 15, this fine porous film having directivity in the direction of the width of the film resin that is orthogonal to the take-off direction of the film resin at the time of manufacture.

FIG. 4A is a schematic block diagram of separator sack 15 of the present invention and is a schematic sectional view of separator sack 15 and positive electrode 13 that is inserted in the separator sack 15. FIG. 4B is an outer schematic view of positive electrode 13 that is housed in separator sack 15.

Two sheet-shaped separators are joined together by fused joined portions 4 with spaces opened between the joined portions that are provided around the circumference of positive electrode 13 to form separator sack 15. Fused sealing portion 5 that continuously joins the two sheet-shaped separators is preferably provided at the outer periphery or inner circumference of fused joined portions 4. Alternatively, fused joined portions 4 need not be provided when fused sealing portion 5 is provided at the inner circumference, or fused joined portions 4 may be joined together to continuously join fused joined portions 4.

Electrode lead-out portion 3 that is an opening is provided in one part of the outer periphery of separator sack 15. Lead-out terminal 2 for current collection of positive electrode 13 inside separator sack 15 is exposed to the exterior of separator sack 15 through this electrode lead-out portion 3. Providing fused joined portions 4 or fused sealing portion 5 at the position of electrode lead-out portion 3 blocks the opening, and fused joined portions 4 or fused sealing portion 5 are therefore not provided at this position. In the present invention, electric insulating layer 8 is provided along the opening of electrode lead-out portion 3. A material that does not undergo thermal contraction or that exhibits less thermal contraction than separator sack 15 is preferably used as electric insulating layer 8.

By adopting this configuration, electrical insulating layer 8 does not contract even in a high-temperature environment, whereby the contraction of separator sack 15 can be suppressed at electrode lead-out portion 3. As a result, positive electrode 13 is not exposed from electrode lead-out portion 3 of separator sack 15. Accordingly, contact and short circuits between overlapping positive electrodes 13 and negative electrodes 14 can be prevented. In addition, even if positive electrodes 13 should be slightly exposed at the positions of electrode lead-out portions 3, the interposition of electrical insulating layer 8 between both electrodes 13 and 14 prevents the occurrence of short circuits between electrodes 13 and 14.

High-temperature environment experiments are next carried out in which several types of stacked units 18 are fabricated and exposed to a high-temperature environment.

Separator sacks 15 that were employed were each fabricated from two sheet-shaped separators having a polyethylene mono-layer construction with break strength in the take-up direction of the film at 1000 kgf/cm² and with break strength in the direction of the width of the film at 1000 kgf/cm².

### Working Example 1

Positive electrode 13 having a height of 100 mm and a width of 50 mm was housed within separator sack 15 fabricated by two sheet-shaped separators each having a height of 104 mm and a width of 54 mm. Fused joined portions 4 having a width of 2 mm were provided around the entire circumference of separator sack 15 with the exception of electrode lead-out portion 3 and fused sealing portion 5 that is continuous with the outer periphery of fused joined portions 4 is further provided. In addition, polypropylene (PP) tape having a width of 2 mm was adhered as electrical insulating layer 8 to electrode lead-out portion 3 aligned with the position of the outer periphery of separator sack 15 so as not to protrude from the outer periphery. The length of the polypropylene (PP) tape was 2 mm longer than the width of lead-out terminal 2. As the polypropylene that makes up this electrode insulating layer 8, a type is used that has the lowest thermal contraction ratio possible or a type is used that has a thermal contraction ratio that is at most lower than that of the polyethylene that makes up the separators. This point is the same in Working Examples 2 and 3 below.

### Working Example 2

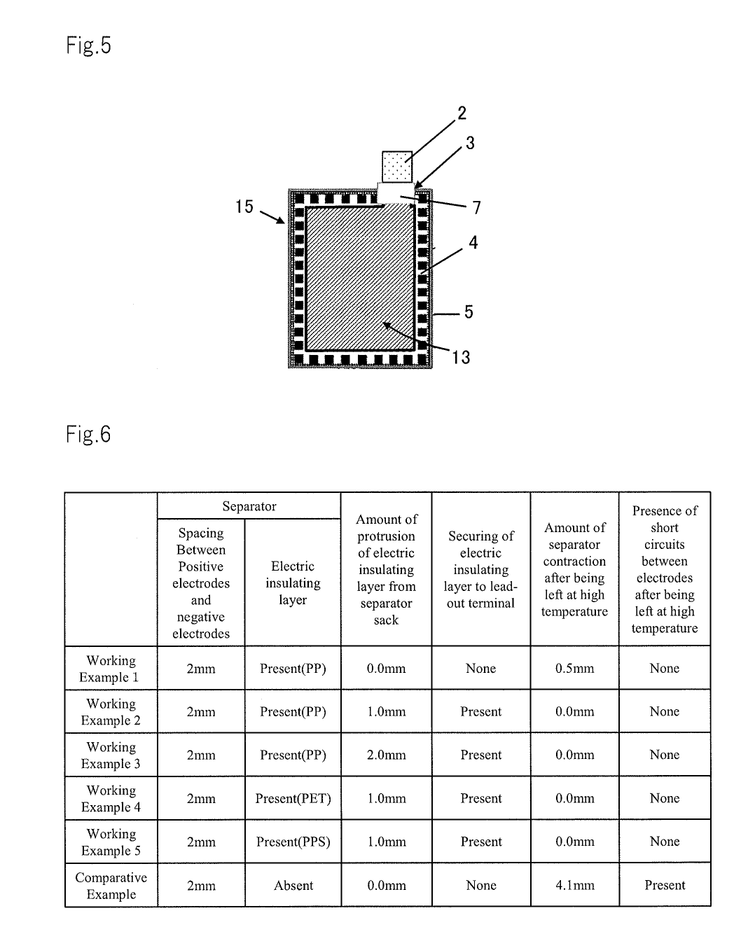

Positive electrode 13 having a height of 100 mm and a width of 50 mm is housed within separator sack 15 that is fabricated from two sheet-shaped separators each having a height of 104 mm and a width of 54 mm. Fused joined portions 4 having a width of 2 mm are provided around the entire circumference of separator sack 15 with the exception of electrode lead-out portion 3, and fused sealing portion 5 that is continuous with the outer periphery of fused joined portions 4 is further provided. Polypropylene (PP) tape having a width of 3 mm is adhered as electrical insulating layer 8 to electrode lead-out portion 3 to secure the protruding portion and lead-out terminal 2 such that the polypropylene tape protrudes 1 mm from the outer periphery of separator sack 15 (see FIG. 5). The length of the polypropylene (PP) tape was made 2 mm longer than the width of lead-out terminal 2.

### Working Example 3

Positive electrode 13 having a height of 100 mm and a width of 50 mm is housed within separator sack 15 that is fabricated from two sheet-shaped separators each having a height of 104 mm and a width of 54 mm. Fused joined portions 4 having a width of 2 mm are provided around the entire circumference of separator sack 15 with the exception of electrode lead-out portion 3, and fused sealing portion 5 that is continuous with the outer periphery of fused joined portions 4 is further provided. Polypropylene (PP) tape having a width of 4 mm was caused to protrude 2 mm from the outer periphery of separator sack 15 as electric insulating layer 8 on electrode lead-out portion 3. The protruding portion was then adhered so as to secure the protruding portion and lead-out terminal 2. The length of the polypropylene (PP) tape was made 2 mm longer than the width of lead-out terminal 2.

### Working Example 4

Positive electrode 13 having a height of 100 mm and a width of 50 mm is housed inside separator sack 15 that is fabricated from two sheet-shaped separators each having a height of 104 mm and a width of 54 mm. Fused joined portions 4 having a width of 2 mm are provided around the entire circumference of separator sack 15 with the exception of electrode lead-out portion 3, and fused sealing portion 5 that is continuous with the outer periphery of fused joined portions 4 is further provided. Polyethylene terephthalate (PET) tape having a width of 3 mm is further caused to protrude 1 mm from the outer periphery of separator sack 15 as electrical insulating layer 8 on electrode lead-out portion 3. The polyethylene terephthalate (PET) tape is then adhered so as to secure the protruding part and lead-out terminal 2. The length of the polyethylene terephthalate (PET) tape was made 2 mm longer than the width of lead-out terminal 2.

### Working Example 5

Positive electrode 13 having a height of 100 mm and a width of 50 mm is housed inside separator sack 15 that is fabricated from two sheet-shaped separators each having a height of 104 mm and a width of 54 mm. Fused joined portions 4 having a width of 2 mm are provided around the entire circumference of separator sack 15 with the exception of electrode lead-out portion 3, and fused sealing portion 5 that is continuous with the outer periphery of fused joined portions 4 is further provided. Polyphenylene sulfide (PPS) tape having a width of 3 mm is further adhered as electrical insulating layer 8 to electrical lead-out portion 3 so as to protrude 1 mm from the outer periphery of separator sack 15 such that the protruding portion and lead-out terminal 2 are secured. The length of the polyphenylene sulfide (PPS) tape is made 2 mm longer than the width of lead-out terminal 2.

### Comparative Example

This example is a method that uses related art similar to that of Patent Document 1. Positive electrode 13 having a height of 100 mm and a width of 50 mm is housed in separator sack 15 fabricated from two sheet-shaped separators each having a height of 104 mm and a width of 54 mm. Fused joined portions 4 having a width of 2 mm are provided around the entire circumference of separator sack 15 with the exception of electrode lead-out portion 3. Fused sealing portion 5 that is continuous with the outer periphery of fused joined portions 4 is further provided.

### Test Conditions

Fourteen positive electrodes 13 that were each inserted in separator sacks 15 fabricated by the above-described methods were prepared for each working example and comparative example, and 15 negative electrodes 14 were prepared that were not inserted in separator sacks 15, each having a height of 100 mm and a width of 50 mm. Negative electrodes 14 and positive electrodes 13 that were housed in separator sacks 15 were then alternately stacked starting in order from negative electrode 14 and further aligned and secured by polypropylene (PP) tape such that the electrodes did not shift up and down or to the right and left to obtain stacked unit 18. At this time, the spacing between positive electrodes and negative electrodes was 2 mm.

Stacked unit 18 that was fabricated in this way was placed in a thermostat oven, the temperature of the thermostat oven then raised to 130±2° C. at 5±2° C./minute, and then maintained at 130±2° C. for 10 minutes. Stacked unit 18 was then sufficiently cooled at room temperature, and the presence or absence of short circuits between positive electrodes 13 and negative electrodes 14 then investigated. Stacked unit 18 was further disassembled and the amount of contraction of electrode lead-out portions 3 of separator sacks 15 measured.

These test conditions were set with reference to Japanese Industrial Standards JISC8712 relating to safety testing of lithium ion secondary cells.

### Test Results

FIG. 6 shows the test results.

In Working Example 1, the portion of electric insulating layer 8 in which electric insulating tape was applied underwent virtually no contraction, but other portions of separator sack 15 contracted. As a result, electrode lead-out portion 3 consequently moved 0.5 mm toward the center of separator sack 15. Nevertheless, positive electrode 13 was not exposed from separator sack 15 and short-circuits did not occur.

In Working Examples 2-5, the portion of electrical insulating layer 8 in which electric insulating tape was applied did not contract, and moreover, because electric insulating tape was secured to lead-out terminal 2, electrode lead-out portion 3 did not move. As a result, positive electrodes 13 were not exposed from separator sack 15 and short circuits did not occur.

In addition, based on the results of Working Examples 3-5, all of polypropylene, polyethylene terephthalate, and polyphenylene sulfide were effective as electric insulating layer 8.

Still further, it was learned based on Working Examples 2 and 3 that it is sufficient to cause electric insulating tape, which was electric insulating layer 8, to protrude approximately 1 mm from the outer periphery of separator sack 15 and then adhere the electric insulating tape to lead-out terminal 2.

On the other hand, in the Comparative Example that used related art such as Patent Document 1, the electrode lead-out portion of the separator sack underwent contraction and the separator sack contracted 4.1 mm at the electrode lead-out portion. As a result, the positive electrode was exposed from the separator sack.

Based on the above-described results, it can be seen that using the stacked secondary cell of the present invention enables prevention of exposure of positive electrodes 13 from separator sacks 15 due to thermal contraction, and as a result, enables prevention of the occurrence of short circuits between positive electrodes 13 and negative electrodes 14. Since only electrodes of one polarity need be housed in separator sacks 15, the present invention can contribute to reducing costs. In addition, even should the occurrence of some contraction of separator sacks 15 cause a portion of positive electrodes 13 to be nearly exposed from separator sacks 15, the interposition of electric insulating layer 8 between positive electrodes 13 and negative electrodes 14 prevents short circuits from occurring.

Although the length of electric insulating layer 8 was made 2 mm longer than the width of lead-out terminal 2, a length that is longer than the width of lead-out terminal 2 is preferable for preventing contraction in the horizontal direction and the length is not limited to 2 mm.

Although positive electrodes 13 were housed in separator sacks 15 in the foregoing explanation, a configuration may be adopted in which negative electrodes 14 are housed in separator sacks 15 and positive electrodes 13 are not housed in separator sacks 15, or in which positive electrodes 13 and negative electrodes 14 are each housed in separator sacks 15.

Although a preferable exemplary embodiment of the present invention has been shown hereinabove and details described, it should be understood that the present invention is not limited to the above-described exemplary embodiment and various modifications and amendments can be made that do not depart from the gist of the present invention.

This application claims the benefits of priority based on Japanese Patent Application No. 2010-114240 for which application was filed on May 18, 2010 and incorporates by citation all of the disclosures of that application.

### EXPLANATION OF REFERENCE NUMBERS

2 lead-out terminal
3 electrode lead-out portion (opening)
4 fused joined portions
5 fused sealing portion
8 electric insulating layer
11 aluminum laminated film
12 electrolyte
13 positive electrode
14 negative electrode
15 separator sack
16 aluminum lead
17 nickel lead
18 stacked unit
19 securing tape

1. A stacked secondary cell comprising:
positive electrodes having lead-out terminals;
negative electrodes having lead-out terminals that are alternately stacked with said positive electrodes with separators interposed;
sack-shaped separator sacks that are each formed by bonding together two sheet-shaped separators and that each house at least one of said positive electrodes and said negative electrodes;
an opening provided in a portion of each of said separator sacks and from which said lead-out terminal of said electrode that is housed in said separator sack protrudes to the exterior; and
an electric insulating layer that covers the outer periphery of said opening.

2. The stacked secondary cell as set forth in claim 1, wherein a portion of said electric insulating layer protrudes from the outer periphery of said separator sack at the position of said opening and is secured to said lead-out terminal of the electrode that is housed in said separator sack.

3. The stacked secondary cell as set forth in claim 1, wherein said separator sack is provided with a plurality of fused joined portions at which two said sheet-shaped separators are joined together with spacing between said fused joined portions at positions other than said opening around the circumference of the electrode that is housed in said separator sack.

4. The stacked secondary cell as set forth in claim 3, wherein a fused sealing portion in which the inner circumference or the outer circumference of said fused joined portions is continuously fused is provided at positions other than said opening, or the spaces between said fused joined portions are fused at positions other than said opening.

5. The stacked secondary cell as set forth in claim 1, wherein said electric insulating layer is composed of a material that does not contract under heat.

6. The stacked secondary cell as set forth in claim 1, wherein said electric insulating layer is polypropylene, polyethylene terephthalate, or polyphenylene sulfide.

7. A short-circuit prevention method of a stacked secondary cell comprising steps of:
housing each of at least one of positive electrodes having lead-out terminals and negative electrodes having lead-out terminals and that are alternately stacked with said positive electrodes with separators interposed in sack-shaped separator sacks that are each formed by bonding together two sheet-shaped separators, and moreover, that each have an opening in one portion;
causing said lead-out terminals of said electrodes that are housed in said separator sacks to protrude to the exterior of said separator sacks via said openings; and
covering the outer peripheries of said openings with electric insulating layers that do not contract under heat such that said openings do not contract even when heat is applied to said separator sacks, such that the electrodes that are housed in said separator sacks are not exposed from said separator sacks, and such that the electrodes that are housed in said separator sacks do not come into contact with other electrodes.

8. The short-circuit prevention method of a stacked secondary cell as set forth in claim 7, wherein the outer periphery of each said opening and said lead-out terminal of the electrode that is housed in said separator sack are joined and secured by said electric insulating layer.
